(19) United States
(12) Patent Application Publication
(10) Pub. No.: US 2013/0146217 A1
(43) Pub. Date: Jun. 13, 2013

(54) Method of Applying Surface Riblets to an Aerodynamic Surface

(71) Applicants: Nicholas Joseph Kray, Mason, OH (US); Gregory Carl Gemeinhardt, Park Hills, KY (US); Dong-Jin Shim, Cohoes, NY (US)

(72) Inventors: Nicholas Joseph Kray, Mason, OH (US); Gregory Carl Gemeinhardt, Park Hills, KY (US); Dong-Jin Shim, Cohoes, NY (US)

(21) Appl. No.: 13/315,550

(22) Filed: Dec. 9, 2011

(51) Int. Cl. B31F 1/20

(52) U.S. Cl. 156/210

(57) ABSTRACT

A method for applying texture to an aerodynamic surface is provided. A master plate is provided having a textured surface. A first material is then applied to that surface and cured forming a caul sheet with a negative impression of the master plate textured surface. A surface to which a texture is to be applied is then provided; this may be an aerodynamic surface. Another material, different from the first, is then applied to the aerodynamic surface and the caul sheet is placed on top. The second material is cured and the caul sheet is removed. The second material is adhered to the aerodynamic surface and has a surface that is substantially a negative impression of the caul sheet textured surface and substantially similar to the master plate textured surface.

### TECHNICAL FIELD

The disclosed embodiments of the present invention generally pertain to gas turbine engines, and particularly to a method of applying surface riblets to aerodynamic surfaces therein.

### BACKGROUND

Riblets disposed on an aerodynamic surface in a proper orientation may result in a reduced drag coefficient of that aerodynamic surface. Therefore, embodiments of the present invention are aimed at creating riblets on aerodynamic surfaces.

### SUMMARY

A method for applying texture to an aerodynamic surface is provided. A master plate is provided having a textured surface. A first material is then applied to that surface and cured forming a caul sheet with a negative impression of the master plate textured surface. A surface to which a texture is to be applied is then provided; this may be an aerodynamic surface. Another material, different from the first, is then applied to the aerodynamic surface and the caul sheet is placed on top. The second material is cured and the caul sheet is removed. The second material is adhered to the aerodynamic surface and has a surface that is substantially a negative impression of the caul sheet textured surface and substantially similar to the master plate textured surface.

### BRIEF DESCRIPTION OF THE ILLUSTRATIONS

Embodiments of the invention are illustrated in the following illustrations.

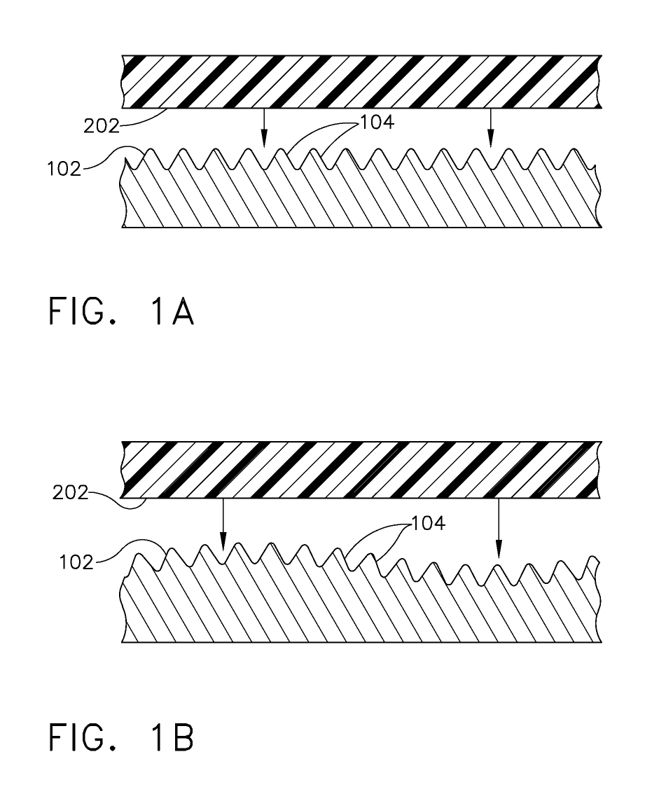

FIGS. 1A and 1B depict methods of forming a caul sheet in accordance with embodiments of the present invention.

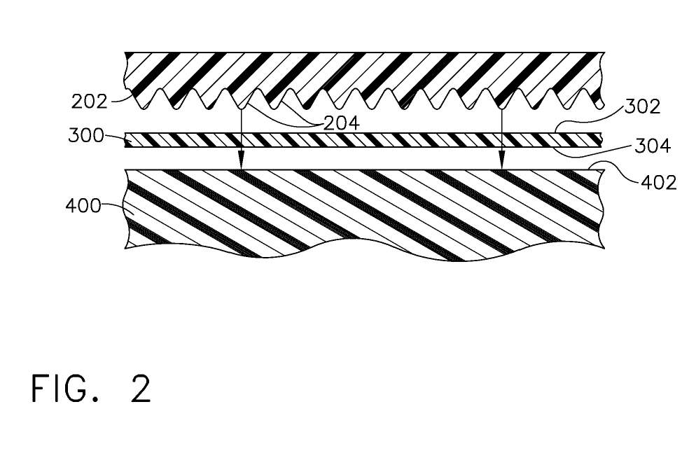

FIG. 2 shows a method of forming riblets in accordance with embodiments of the present invention.

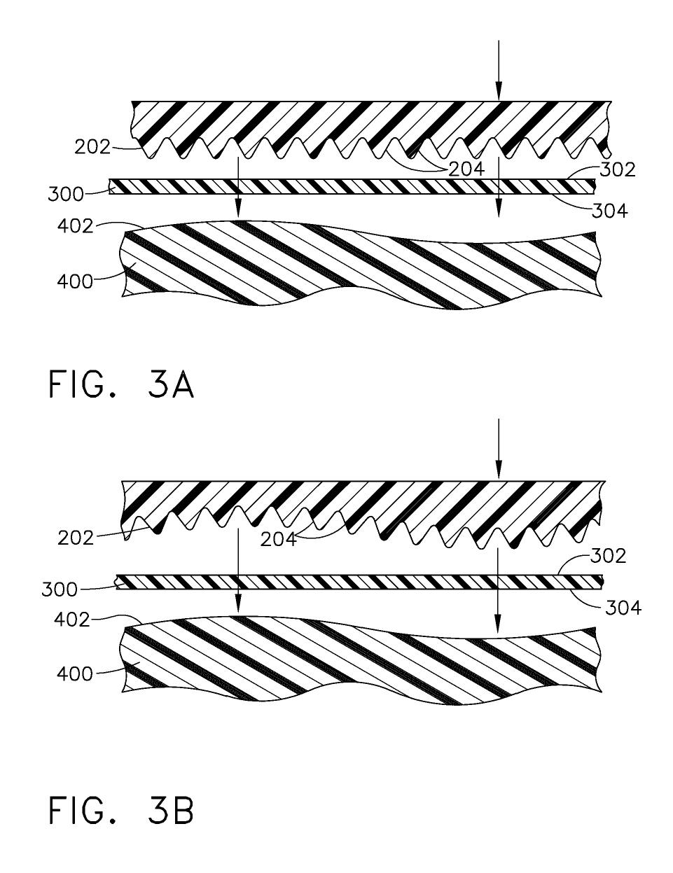

FIGS. 3A and 3B illustrate methods of forming riblets on a contoured surface in accordance with embodiments of the present invention.

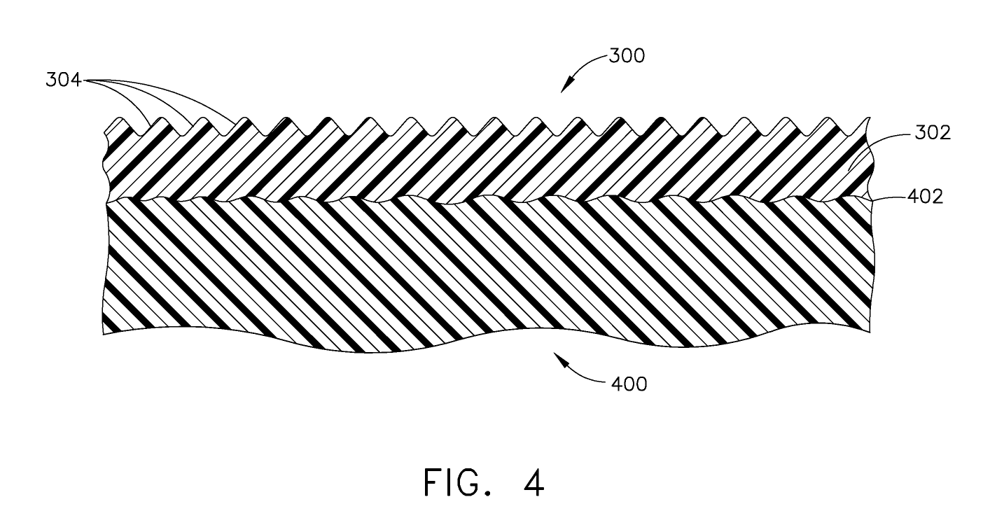

FIG. 4 is a cross-sectional view of a riblets formed on a surface by a method in accordance with embodiments of the present invention.

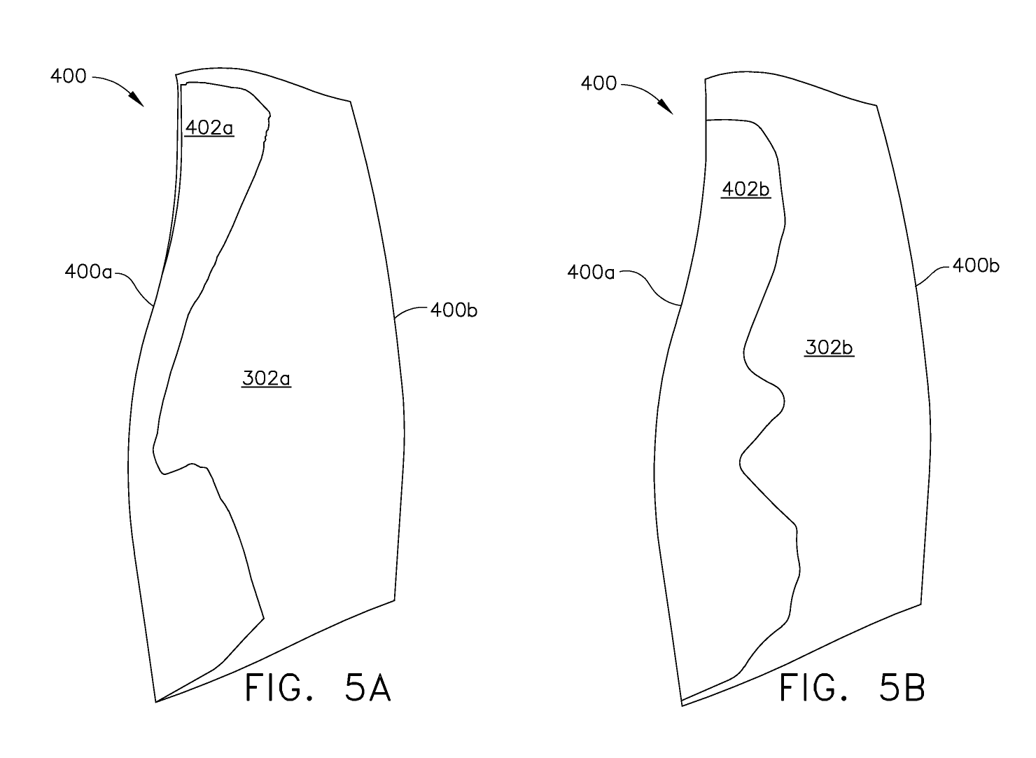

FIG. 5A represents an area on an airfoil suction side that has had riblets applied to it by methods in accordance with embodiments of the present invention.

FIG. 5B represents an area on an airfoil pressure side that has had riblets applied to it by methods in accordance with embodiments of the present invention.

### DETAILED DESCRIPTION

Referring now to FIGS. 1A and 1B, an embodiment of a method in accordance with the present invention is depicted for producing a caul sheet 200. A master plate 100 is provided having a first surface 102 with a plurality of ridges or ridges 104 disposed thereon. FIG. 1A depicts a master plate 100 has having a flat surface 102 for creating a caul sheet 200 having a flat textured surface 202, while FIG. 1B shows a master plate 100 with a contoured surface 102 for creating a caul sheet 200 with a contoured textured surface 202 (showed as contoured in FIG. 3B). Further, a caul sheet 200 may be manufactured have both flat surface portions and contoured surface portions.

The master plate 100 may be formed using any known techniques, including, but not limited to, physical machining, chemical etching, electric discharge machining, or any combination thereof.

The caul sheet 200 is formed by first applying a curable and flowable material onto the master plate textured surface 102. The caul sheet material 200 should flow about the master plate ridges 104 and completely fill any gaps between ridges 104. Preferably, the caul sheet material will completely encapsulate all surface features of the master plate 100 (riblets, gaps therebetween, and any contour) free of any air pockets or voids. The caul sheet material 200 may be any suitable material, which may be, for example, a rubber material. Though not shown, the master plate 100 may have walls about its perimeter and/or a backing plate. This may be done in order to keep the caul sheet material 200 in place and maintain a uniform thickness while it is being cured. Curing the caul sheet material 200 is the next step in forming the caul sheet 200. The curing process is dependent upon the choice of caul sheet material. This curing process may include, but is not limited to, an application of heat and pressure, or a combination thereof. Once cured, the caul sheet material 200 may simply be referred to as a caul sheet 200 and may be removed from the master plate 100.

Referring now to FIGS. 2, 3A, and 3B, the caul sheet 200 will have a surface 202 with a plurality of grooves 204. The surface 202 and plurality of grooves 204 will substantially be a negative impression of the master plate surface 202 and plurality of riblets 204 disposed thereon.

An aerodynamic surface 402, such as that on an airfoil 400, is provided for applying surface riblets thereon. An aerodynamic surface 402 may include any surface exposed to a fluid flow, including, for example, an airfoil or vane surface, or a platform of a blade. For simplicity, the method described herein is directed to the application of riblets on an airfoil surface. A film material 300 is applied to the airfoil surface 402 in a substantially uniform thickness. The film material 300 is preferably curable and flowable. The film material 300 may be any suitable material and may be the same or similar to that which is used in the application of erosion coats on composite airfoils. This material 300 may be, for example, polyurethane. A caul sheet 200 made from the process described herein may then be applied on top of the film material 300, such that the film material 300 is disposed between the caul sheet 200 and the airfoil surface 402. The caul sheet 200 is pressed into the film material 300 such that the film material 300 completely flows into the caul sheet grooves 204 and surrounding caul sheet surface 202, preferably free of air pockets and voids.

Curing the film material 300 is the next step in forming riblets 304 (FIG. 4) on a surface thereon 302. The curing process is dependent upon the choice of film material 300. This curing process may include, but is not limited to, an application of heat and pressure, or a combination thereof. Once cured, the film material 300 may simply be referred to as a film layer 300. After curing, the film layer 300 should be adhered to the airfoil surface 402 at an interface between the film layer 300 and airfoil surface 402. At this point, the caul sheet 200 may be removed. It is important to note that because the caul sheet 200 goes through the film material's curing process, the selection of caul sheet material should be capable of withstanding this process.

FIG. 2 depicts a caul sheet 200 with a flat surface 202 being utilized with a flat airfoil surface 402. FIG. 3A depicts a caul sheet 200 with a flat surface 202 being utilized with a contoured airfoil surface 402. FIG. 3B depicts a caul sheet 200 with a contoured surface 202 being utilized with a contoured airfoil surface 402. The above process for applying and curing the film layer 300 to an airfoil surface 402 is substantially the same for the different scenarios depicted in FIGS. 2, 3A, and 3B.

The type of caul sheet 200 utilized (flat or contoured) will depend on the amount of contour on the airfoil surface 402 as well as the flexing nature of the caul sheet 200. For instance and as shown in FIG. 3A, an airfoil surface 402 may have minor contours and the caul sheet 200 may be substantially flat, but sufficiently flexible to conform to the contours of the airfoil surface 402 while still not deforming to an extent that would result in unacceptable riblets 304 (FIG. 4). As shown in FIG. 3B, the contoured airfoil surface 402 may be beyond the flexible capabilities of the caul sheet 200, such that flexing the caul sheet 200 to conform to the surface contours would deform the features of the caul sheet too greatly to form acceptable riblets 304. Therefore, when an airfoil surface 402 is contoured beyond the flexing capabilities of a caul sheet 200, a caul sheet 200 with a contoured surface 202 should be utilized. Preferably the contours of the caul sheet 200 and airfoil surface 402 should be substantially similar. Further, it is possible that an airfoil surface 402 may have flat and contoured portions, in which case the caul sheet 200 should have the same surface topography. Properly matching the caul sheet contours with the airfoil contours also helps to maintain the film layer 300 in a uniform thickness.

Referring now to FIG. 4, once the caul sheet 200 is removed from the film layer 300, the film layer 300 will have an exposed surface 302 with a plurality of riblets 304. The riblets 304 formed in the film surface 302 and adhered to the airfoil surface 402 may vary in height from about 0.050 mm to 0.254 mm. The film layer surface 302 and riblets 304 should substantially be a negative impression of that on the caul sheet 200, and should be substantially the same as the ridge 104 pattern on the master plate 100.

A desired riblet pattern on an airfoil 400 varies greatly about the airfoil surface 402. It may vary in density from one part of the surface to another; the riblets may have a variation in height over the airfoil surface 402; and the riblets may change in orientation in order to be aligned with local airflow. Accordingly, the ridges 104 on the master plate 100 should also vary in density, height, and orientation. An optimal riblet pattern may be determined by computational and experimental analysis for a given aerodynamic surface geometry and the operating conditions in which it is to be employed.

The ridges 104 disposed on the master plate surface 102 are disposed in a pattern that preferably substantially mimics a pattern of riblets 304 applied to an airfoil surface 402. However, the master plate ridges 104 may not necessarily be an exact replica of the desired riblets 304. Some factors that may influence this difference may include, for example, shrinkage of materials during their respective curing processes, and flexing of the caul sheet 200 to match the airfoil surface 402 contours. Accordingly, one should determine the desired riblet 304 dimensions, density, and orientations about the airfoil surface 402, and then take into account the above factors to arrive at a pattern that should be utilized on the master plate 100.

FIG. 5A depicts a suction side 402a of an airfoil 400, and FIG. 5B depicts a pressure side 402b of an airfoil 400. Both airfoil sides have had riblets applied thereon in a manner consistent with the methods described herein. The film layer 302 need not be applied to the entire airfoil surface 402a, 402b. As shown in FIGS. 5A and 5B, the film layer is not applied to the airfoil leading edges 400a, 400b. The riblet pattern on the trailing edge 400b, however, may vary greatly along the length of the airfoil 400.

As used herein, the terms “flat” and “contour,” and variations thereof, are referenced several times. These terms are not meant to imply that, where applicable, a surface texture is not present. For instance, the master plate textured surface 102 has been described as being flat or contoured. However, it is understood that the description of “flat” or “contoured” does not negate the fact that the master plate surface 102 does not still possess ridges 104 thereon. The same applies to the caul sheet surface 102 and the grooves 104 therein, as well as the film layer surface 302 and the riblets thereon 304. The terms “flat” and “contoured,” and their respective variants, as used herein and in the appended claims are to be taken as a general description of the surfaces they describe.

The foregoing description of structures and methods has been presented for purposes of illustration. It is not intended to be exhaustive or to limit the invention to the precise steps and/or forms disclosed, and obviously many modifications and variations are possible in light of the above teaching. Features described herein may be combined in any combination. Steps of a method described herein may be performed in any sequence that is physically possible. It is understood that while certain forms of a method for applying riblets to an aerodynamic surface have been illustrated and described, it is not limited thereto and instead will only be limited by the claims, appended hereto.

1. A method for applying texture to an aerodynamic surface, comprising the steps of:
providing a master plate having a first textured surface;
applying a first material that is flowable and curable to said first textured surface;
curing said first material with heat and pressure, such that it is a cured first material and no longer flowable and has a second textured surface with a negative impression of the first textured surface thereon;
providing a gas turbine engine component which comprises an aerodynamic surface;
applying a second material that is flowable and curable to at least a portion of said aerodynamic surface;
positioning said cured first material on said second material, such that said second material is in contact with and disposed between said second textured surface and said at least a portion of said aerodynamic surface;
curing said second material with heat and pressure, such that it is a cured second material and no longer flowable and adhered to said at least a portion of said aerodynamic surface; and
removing said cured first material from contact with said cured second material.

2. The method of claim 1, wherein said first textured surface is generally flat.

3. The method of claim 1, wherein said aerodynamic surface is contoured and said first textured surface is contoured.

4. The method of claim 1, wherein removing said first material from contact with said second material provides said second material with a third textured surface comprising a substantially negative impression of said second textured surface.

5. The method of claim 4, wherein said third textured surface is substantially identical to said first textured surface.

6. The method of claim 4, wherein said third textured surface comprises a plurality of riblets.

7. The method of claim 6, wherein said plurality of riblets have a variation in orientation such that, at any given location on said at least a portion of said aerodynamic surface, a subset of said plurality of riblets at said any given location are aligned with an airflow that is expected to be found at said any given location.

8. The method of claim 1, wherein said first material at least partially comprises rubber.

9. The method of claim 1, wherein said second material at least partially comprises polyurethane.

10. The method of claim 1, wherein said second material is viscoelastic.

11. A method for applying texture to an aerodynamic surface, comprising the steps of:
providing a flexible caul sheet having a first textured surface thereon;
providing a gas turbine engine component having an aerodynamic surface;
applying a curable and flowable material to at least a portion of said aerodynamic surface;
positioning said flexible caul sheet on said curable and flowable material, such that said textured surface contacts said curable and flowable material;
curing said curable and flowable material, such that it is a cured material and no longer flowable; and
removing said flexible caul sheet from said cured material.

12. The method of claim 11, wherein said cured material is adhered to said at least a portion of said aerodynamic surface.

13. The method of claim 11, wherein said cured material is provided with a second textured surface that is a negative impression of said first textured surface.

14. The method of claim 13, wherein said second textured surface comprises a plurality of riblets.

15. The method of claim 14, wherein said plurality of riblets have a variation in orientation such that, at any given location on said at least a portion of said aerodynamic surface, a subset of said plurality of riblets at said any given location are aligned with an airflow that is expected to be found at said any given location.

16. The method of claim 11, wherein said caul sheet is at least partially comprised of a cured rubber.

17. The method of claim 11, wherein said curable and flowable material is at least partially comprised of polyurethane.

18. The method of claim 11, wherein said aerodynamic surface is contoured and said first textured surface is contoured.

19. The method of claim 18, wherein said aerodynamic surface contour and said first textured surface contour are similarly contoured.
